(19) United States
(12) Patent Application Publication
(10) Pub. No.: US 2025/0193015 A1
(43) Pub. Date: Jun. 12, 2025

(54) USER AUTHENTICATION INFORMATION-BASED REGISTRATION METHOD AND APPARATUS AND USER AUTHENTICATION INFORMATION-BASED QUERY METHOD AND APPARATUS

(71) Applicant: Alipay (Hangzhou) Information Technology Co., Ltd., Hangzhou (CN)

(72) Inventors: Zhenghao WU, Hangzhou (CN); Jinming CUI, Hangzhou (CN); Xiaojian LIANG, Hangzhou (CN); Pu DUAN, Hangzhou (CN)

(21) Appl. No.: 18/975,603

(22) Filed: Dec. 10, 2024

(30) Foreign Application Priority Data
Dec. 11, 2023 (CN) 202311690525.8

(51) Int. Cl. H04L 9/32; H04L 9/06; H04L 9/08; H04L 9/30

(52) U.S. Cl. CPC H04L 9/3226; H04L 9/0618; H04L 9/0869; H04L 9/3073

(57) ABSTRACT

Embodiments of this specification provide a user authentication information-based registration method and apparatus and a user authentication information-based query method and apparatus. The registration method includes: User equipment receives authentication information submitted by a first user in a process of registering with a server; obtains a public-private key pair by using a key generation algorithm and based on the random number r and a public parameter pp; performs a hash operation based on at least the password pwd, to obtain a user key value user_key; obtains a registration ciphertext C_{register} by using an encryption algorithm and based on the public key pk and the user key value user_key; obtains, based on the private key sk and the registration ciphertext C_{register}, a determining trapdoor td_{register} that matches the registration ciphertext C_{register}; and uploads the registration ciphertext C_{register} and the determining trapdoor td_{register} to the server.

### TECHNICAL FIELD

One or more embodiments of this specification relate to the computer field, and in particular, to a user authentication information-based registration method and apparatus and a user authentication information-based login method and apparatus.

### BACKGROUND

Currently, an identity of a user often needs to be authenticated, to avoid a case in which the identity of the user is stolen and consequently losses are caused to rights and interests of the user. For example, privacy information of the user is disclosed. With people's increasing awareness of privacy protection, a conventional identity authentication method is constantly challenged.

An authentication solution usually includes two processes: registration and login. Authentication information of a user includes a password of the user. In the conventional identity authentication method, in the two processes, the password or a hash value of the password needs to be transmitted on a network, and the server directly stores the password of the user or the hash value of the password. When the server is attacked or an administrator of the server actively engages in malicious activities, the password or the hash value of the password is disclosed, and this method is vulnerable to dictionary attacks. Even if a salt is used to increase randomness, when the server stores a salt value of the user and a hash value of the salt value to resist the above-mentioned dictionary attacks, there are still many other information disclosure risks. For example, the password or the hash value of the password may be directly obtained by a man-in-the-middle attack in a transmission process. In addition, people are accustomed to using a same password on different websites, and therefore can log in to other systems by using the same password. Once the above-mentioned attack is made, information about the user on other websites may be simultaneously disclosed, resulting in a greater risk of user privacy disclosure.

### SUMMARY

One or more embodiments of this specification describe a user authentication information-based registration method and apparatus and a user authentication information-based query method and apparatus, to improve security and reduce the risk of user privacy disclosure.

According to a first aspect, a user authentication information-based registration method is provided. The method is performed by user equipment and includes:
receiving authentication information submitted by a first user in a process of registering with a server, wherein the authentication information includes a password pwd of the first user;
obtaining a random number r;
obtaining a public-private key pair including a public key pk and a private key sk by using a key generation algorithm and based on the random number r and a public parameter pp;
performing a hash operation based on at least the password pwd of the first user, to obtain a user key value user_key;
obtaining a registration ciphertext C_{register} by using an encryption algorithm and based on the public key pk and the user key value user_key, wherein the encryption algorithm generates a random number and performs encryption based on the random number;
obtaining, by using a trapdoor generation algorithm and based on the private key sk and the registration ciphertext C_{register}, a determining trapdoor td_{register} that matches the registration ciphertext C_{register}; and
uploading the registration ciphertext C_{register} and the determining trapdoor td_{register} to the server, so that the server stores the registration ciphertext C_{register} and the determining trapdoor td_{register} as authentication information of the first user, wherein the authentication information is used to perform identity authentication on the first user.

In a possible implementation, the obtaining a random number r includes:
jointly executing an oblivious pseudorandom function OPRF with the server based on a locally held input x and a key k held by the server, to obtain the random number r.

Further, the locally held input x is obtained in the following manner:
obtaining a derived password derived_pwd by using a random extraction function and based on the password pwd of the first user, and using the derived password as the input x.

Further, the key k held by the server is obtained in the following manner:

The server obtains the key k by using a random extraction function and based on a seed held by the server.

Further, the performing a hash operation based on at least the password pwd of the first user, to obtain a user key value user_key includes:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

According to a second aspect, a user authentication information-based login method is provided. The method is performed by user equipment and includes:
receiving authentication information submitted by a first user in a process of logging in to a server, wherein the authentication information includes a password pwd of the first user;
restoring a random number r used in a registration process;
obtaining a public-private key pair including a public key pk and a private key sk by using a key generation algorithm and based on the random number r and a public parameter pp;
performing a hash operation based on at least the password pwd of the first user, to obtain a user key value user_key;
obtaining a login ciphertext C_{login} by using an encryption algorithm and based on the public key pk and the user key value user_key, wherein the encryption algorithm generates a random number and performs encryption based on the random number;
obtaining, by using a trapdoor generation algorithm and based on the private key sk and the login ciphertext C_{login}, a determining trapdoor td_{login} that matches the login ciphertext C_{login}; and
uploading the login ciphertext C_{login} and the determining trapdoor td_{login} to the server, so that the server determines, by using an equality test function and based on a registration ciphertext C_{register}, a determining trapdoor td_{register}, the login ciphertext C_{login}, and the determining trapdoor td_{login}, whether the first user successfully logs in.

In a possible implementation, the restoring a random number r used in a registration process includes:
jointly executing an oblivious pseudorandom function OPRF with the server based on a locally held input x and a key k held by the server, to obtain the random number r.

Further, the locally held input x is obtained in the following manner:
obtaining a derived password derived_pwd by using a random extraction function and based on the password pwd of the first user, and using the derived password as the input x.

Further, the key k held by the server is obtained in the following manner:

The server obtains the key k by using a random extraction function and based on a seed held by the server.

Further, the performing a hash operation based on at least the password pwd of the first user, to obtain a user key value user_key includes:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

According to a third aspect, a user authentication information-based registration apparatus is provided. The apparatus is disposed in user equipment and includes:
a receiving unit, configured to receive authentication information submitted by a first user in a process of registering with a server, wherein the authentication information includes a password pwd of the first user;
an obtaining unit, configured to obtain a random number r;
a key generation unit, configured to obtain a public-private key pair including a public key pk and a private key sk by using a key generation algorithm and based on the random number r obtained by the obtaining unit and a public parameter pp;
a hash operation unit, configured to perform a hash operation based on at least the password pwd of the first user received by the receiving unit, to obtain a user key value user_key;
an encryption unit, configured to obtain a registration ciphertext C_{register} by using an encryption algorithm and based on the public key pk obtained by the key generation unit and the user key value user_key obtained by the hash operation unit, wherein the encryption algorithm generates a random number and performs encryption based on the random number;
a trapdoor generation unit, configured to obtain, by using a trapdoor generation algorithm and based on the private key sk obtained by the key generation unit and the registration ciphertext C_{register} obtained by the encryption unit, a determining trapdoor td_{register} that matches the registration ciphertext C_{register}, and
an uploading unit, configured to upload the registration ciphertext C_{register} obtained by the encryption unit and the determining trapdoor td_{register} obtained by the trapdoor generation unit to the server, so that the server stores the registration ciphertext C_{register} and the determining trapdoor td_{register} as authentication information of the first user, wherein the authentication information is used to perform identity authentication on the first user.

According to a fourth aspect, a user authentication information-based login apparatus is provided. The apparatus is disposed in user equipment and includes:
a receiving unit, configured to receive authentication information submitted by a first user in a process of logging in to a server, wherein the authentication information includes a password pwd of the first user;
a restoration unit, configured to restore a random number r used in a registration process;
a key generation unit, configured to obtain a public-private key pair including a public key pk and a private key sk by using a key generation algorithm and based on the random number r obtained by the restoration unit and a public parameter pp;
a hash operation unit, configured to perform a hash operation based on at least the password pwd of the first user obtained by the receiving unit, to obtain a user key value user_key;
an encryption unit, configured to obtain a login ciphertext C_{login} by using an encryption algorithm and based on the public key pk obtained by the key generation unit and the user key value user_key obtained by the hash operation unit, wherein the encryption algorithm generates a random number and performs encryption based on the random number;
a trapdoor generation unit, configured to obtain, by using a trapdoor generation algorithm and based on the private key sk obtained by the key generation unit and the login ciphertext C_{login} obtained by the encryption unit, a determining trapdoor td_{login} that matches the login ciphertext C_{login}; and
an uploading unit, configured to upload the login ciphertext C_{login} obtained by the encryption unit and the determining trapdoor td_{login} obtained by the trapdoor generation unit to the server, so that the server determines, by using an equality test function and based on a registration ciphertext C_{register}, a determining trapdoor td_{register}, the login ciphertext C_{login}, and the determining trapdoor td_{login}, whether the first user successfully logs in.

According to a fifth aspect, a computer-readable storage medium is provided. The computer-readable storage medium stores a computer program, and when the computer program is executed in a computer, the computer is enabled to perform the method according to the first aspect or the second aspect.

According to a sixth aspect, a computing device is provided, including a memory and a processor. The memory stores executable code, and when the processor executes the executable code, the method according to the first aspect or the second aspect is implemented.

According to the user authentication information-based registration method and apparatus provided in the embodiments of this specification, user equipment first receives authentication information submitted by a first user in a process of registering with a server, wherein the authentication information includes a password pwd of the first user; then obtains a random number r; then obtains a public-private key pair including a public key pk and a private key sk by using a key generation algorithm and based on the random number r and a public parameter pp; then performs a hash operation based on at least the password pwd of the first user, to obtain a user key value user_key; then obtains a registration ciphertext C_{register} by using an encryption algorithm and based on the public key pk and the user key value user_key, wherein the encryption algorithm generates a random number and performs encryption based on the random number; then obtains, by using a trapdoor generation algorithm and based on the private key sk and the registration ciphertext C_{register}, a determining trapdoor td_{register} that matches the registration ciphertext C_{register}; and finally uploads the registration ciphertext C_{register} and the determining trapdoor td_{register} to the server, so that the server stores the registration ciphertext C_{register} and the determining trapdoor td_{register} as authentication information of the first user, wherein the authentication information is used to perform identity authentication on the first user. It can be learned from the above-mentioned descriptions that in the embodiments of this specification, authentication information stored in the server is not a plaintext password held by a user or a hash value of a password, but is a ciphertext of a user key and a determining trapdoor. In this case, even if the information in the server is disclosed, it is not vulnerable to dictionary attacks, and the information cannot be used to log in to another system that uses a same password. This can improve security and reduce the risk of user privacy disclosure.

According to the user authentication information-based login method and apparatus provided in the embodiments of this specification, user equipment first receives authentication information submitted by a first user in a process of logging in to a server, wherein the authentication information includes a password pwd of the first user; then restores a random number r used in a registration process; then obtains a public-private key pair including a public key pk and a private key sk by using a key generation algorithm and based on the random number r and a public parameter pp; then performs a hash operation based on at least the password pwd of the first user, to obtain a user key value user_key; then obtains a login ciphertext C_{login} by using an encryption algorithm and based on the public key pk and the user key value user_key, wherein the encryption algorithm generates a random number and performs encryption based on the random number; then obtains, by using a trapdoor generation algorithm and based on the private key sk and the login ciphertext C_{login}, a determining trapdoor td_{login} that matches the login ciphertext C_{login}; and finally uploads the login ciphertext C_{login} and the determining trapdoor td_{login} to the server, so that the server determines, by using an equality test function and based on a registration ciphertext C_{register}, a determining trapdoor td_{register}, the login ciphertext C_{login}, and the determining trapdoor td_{login}, whether the first user successfully logs in. It can be learned from the above-mentioned descriptions that in a user login process, authentication information transmitted by the user equipment to the server is not a plaintext password held by a user or a hash value of a password, but is a ciphertext of a user key and a determining trapdoor. In this case, even if the information is disclosed in a transmission process, the information cannot be used to log in to another system that uses a same password. This can improve security and reduce the risk of user privacy disclosure.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram of an implementation scenario of an embodiment disclosed in this specification;

FIG. 2 is a flowchart of a user authentication information-based registration method according to an embodiment;

FIG. 3 is a flowchart of a user authentication information-based login method according to an embodiment;

FIG. 4 is a schematic interaction diagram of a user authentication information-based registration phase according to an embodiment;

FIG. 5 is a schematic interaction diagram of a user authentication information-based login phase according to an embodiment;

FIG. 6 is a schematic block diagram of a user authentication information-based registration apparatus according to an embodiment; and

FIG. 7 is a schematic block diagram of a user authentication information-based login apparatus according to an embodiment.

### DESCRIPTION OF EMBODIMENTS

The solutions provided in this specification are described below with reference to the accompanying drawings.

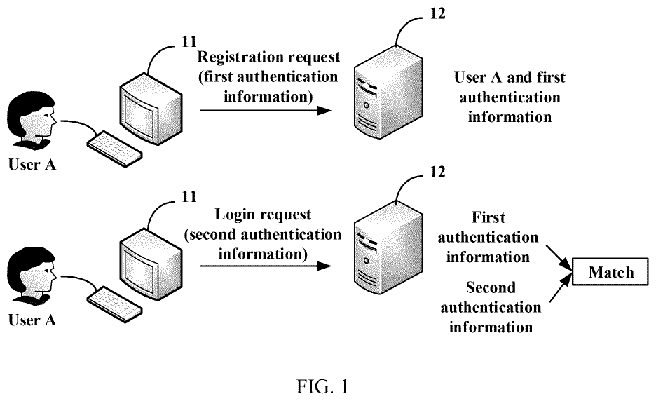

FIG. 1 is a schematic diagram of an implementation scenario of an embodiment disclosed in this specification. This implementation scenario relates to user authentication information-based registration and login. With reference to FIG. 1, an authentication solution is divided into a registration process and a login process. In the registration process, a user sends a registration request to a server 12 by using user equipment 11, where the registration request carries first authentication information, and the server 12 correspondingly stores the first authentication information and a user identifier of the user. For example, stored information is a mapping relationship between the user A and the first authentication information, and the stored information is used to subsequently authenticate an identity of the user A in the login process. In the login process, the user sends a login request to the server 12 by using the user equipment 11, where the login request carries second authentication information, and the server 12 matches the second authentication information with the first authentication information. If the matching succeeds, the user successfully logs in. It can be understood that both the first authentication information and the second authentication information are generated based on a password held by the user. If the matching succeeds, it means that the user who requests to log in holds a password of a corresponding identity, the identity authentication succeeds, and the user successfully logs in. In the embodiments of this specification, the following privacy information needs to be protected from being obtained by an external malicious enemy: a password of a user. The following security guarantees are required: A registered user can log in to a system, and an unregistered user cannot log in to the system; there are the following participants in the system: a server and user equipment; and there are the following phases in the system: a registration phase and login phase.

In the embodiments of this specification, the user equipment can be but is not limited to a mobile phone, a tablet, a computer, etc. The server can be but is not limited to a server of a website.

In the embodiments of this specification, improvements are made to a conventional authentication method, including improvements to a registration process and improvements to a login process. Authentication information stored in the server is not a plaintext password held by a user or a hash value of a password, but is a ciphertext corresponding to the password, and a user identity is authenticated based on equality test, to improve security and reduce the risk of user privacy disclosure.

The following algorithms in public key encryption with equality test supporting flexible authorization (PKEET-FA) can be involved:

Algorithm ppSetup←(1^{λ}): The algorithm is a solution initialization algorithm, an input is a security parameter 1^{λ}, and an output is a public parameter pp.

It can be understood that the security parameter is an input to the algorithm, and a security level corresponding to the security parameter 1^{λ} is λ bits. For example, when λ is 128, the security level is 128 bits. The public parameter is a parameter at a corresponding security level generated based on the security parameter. Generation of the public parameter can include selection of a bilinear pairing group and selection of two hash functions.

Algorithm sk, pk←KeyGen (pp; r): The algorithm is a key generation algorithm, and outputs a public-private key pair, where r represents a random factor used in a KeyGen process.

It can be understood that Keygen performs key initialization by using the public parameter pp as an input. The random factor r is a simplified representation, and can include a random factor x, y, and z. An output is a public key pk and a private key sk.

Algorithm c←Enc (pk, m): The encryption algorithm outputs a ciphertext c based on the public key pk and plaintext information m.

It can be understood that the ciphertext c is a simplified representation, and can include ciphertexts c₁, c₂, c₃, and c₄.

Algorithm m←Dec (sk, c): The decryption algorithm outputs plaintext information m based on the private key sk and the ciphertext c.

It can be understood that the public key pk and the private key sk are a public-private key pair, the public key is used in an encryption process, and the private key is used in a decryption process.

Algorithm 1/0←Test(td₁, c₁, td₂, c₂): When the equality test algorithm outputs 1 based on input trapdoors td₁ and td₂, the ciphertext c₁, and the ciphertext c₂, it indicates that underlying plaintexts of the ciphertexts are the same; or when the equality test algorithm outputs 0, it indicates that underlying plaintexts of the ciphertexts are different.

It can be understood that the ciphertext c₁ and the ciphertext c₂ are different. However, plaintext information corresponding to the two ciphertexts may be the same. By using the equality test algorithm, it can be determined whether the underlying plaintexts of the two ciphertexts are the same.

Algorithm tdᵢ←Trapdoor(sk, cᵢ): The trapdoor generation algorithm is run based on the private key sk and a ciphertext cᵢ, and an output is used to determine a trapdoor tdᵢ of the ciphertext cᵢ.

It can be understood that there is a correspondence between a ciphertext cᵢ and a trapdoor tdᵢ, and different ciphertexts usually correspond different trapdoors.

An authentication solution usually includes a registration process and a login process. The solutions provided in the embodiments of this specification are separately described below for the registration process and the login process.

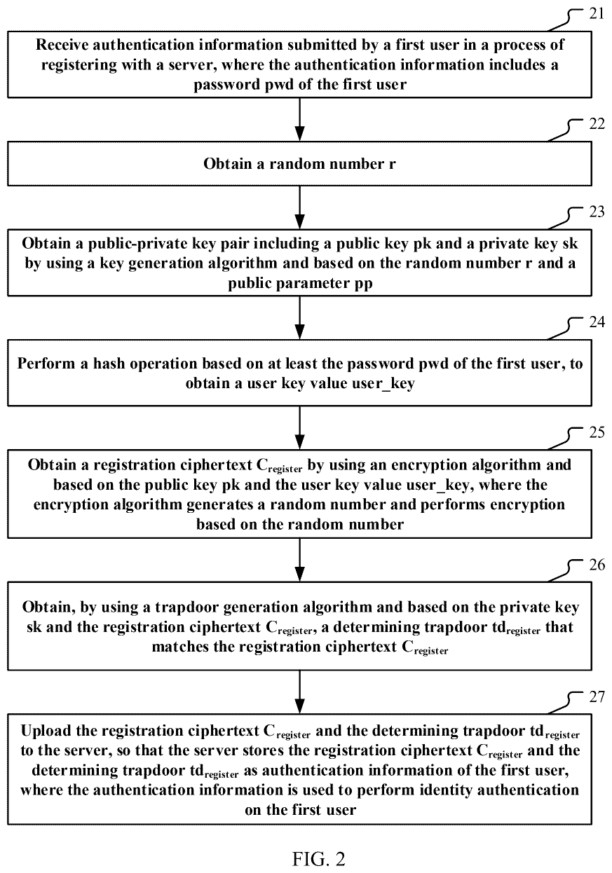

FIG. 2 is a flowchart of a user authentication information-based registration method according to an embodiment. The method can be performed by user equipment based on the implementation scenario shown in FIG. 1. As shown in FIG. 2, the user authentication information-based registration method in this embodiment includes the following steps: Step 21: Receive authentication information submitted by a first user in a process of registering with a server, where the authentication information includes a password pwd of the first user; step 22: Obtain a random number r; step 23: Obtain a public-private key pair including a public key pk and a private key sk by using a key generation algorithm and based on the random number r and a public parameter pp; step 24: Perform a hash operation based on at least the password pwd of the first user, to obtain a user key value user_key; step 25: Obtain a registration ciphertext C_{register} by using an encryption algorithm and based on the public key pk and the user key value user_key, where the encryption algorithm generates a random number and performs encryption based on the random number; step 26: Obtain, by using a trapdoor generation algorithm and based on the private key sk and the registration ciphertext C_{register}, a determining trapdoor td_{register} that matches the registration ciphertext C_{register}, and step 27: Upload the registration ciphertext C_{register} and the determining trapdoor td_{register} to the server, so that the server stores the registration ciphertext C_{register} and the determining trapdoor td_{register} as authentication information of the first user, where the authentication information is used to perform identity authentication on the first user. Specific manners of performing the above-mentioned steps are described below.

First, in step 21, the authentication information submitted by the first user in the process of registering with the server is received, where the authentication information includes the password pwd of the first user. It can be understood that the first user can input the authentication information to the user equipment by using an input device such as a keyboard.

The password pwd can be a combination of numbers, a combination of numbers and letters, or a combination of numbers, letters, and special symbols, which is easy for the user to remember. There may be many cases, and are not listed one by one herein.

It can be understood that the password pwd is privacy information of the first user, and if the password pwd is obtained by another user, the identity of the first user may be stolen. For example, the another user logs in to a website by using the identity of the first user.

Then, in step 22, the random number r is obtained. It can be understood that the random number r can be independently generated by the user equipment by using a pseudorandom function, or can be jointly generated by the user equipment and the server by using an oblivious pseudorandom function.

The pseudorandom function (PRF) is a deterministic function f: X×Y→Z defined in space X, Y, and Z, where X is key space, Y is input space (a domain), and Z is range space. If f is a pseudorandom function, an output fₖ(x) of the function for any input x should be indistinguishable from a true random number.

The oblivious pseudorandom function (OPRF) is a two-party interactive protocol that runs between the user equipment and the server, and implements two-party computation of the pseudorandom function f. The user equipment holds an input x, the server holds a key k, and the user equipment outputs fₖ(x) after the OPRF protocol is run.

For example, if the server holds a key k∈ [symbol] ₚ, and the user equipment holds an input x∈ [symbol] ₚ, where [symbol] ₚ represents an integer group whose modulus is p, p is usually a 256-bit length, and [symbol] represents an elliptic curve group, the interactive OPRF protocol has the following process: The user equipment selects a random number t∈ [symbol] ₚ, runs a blind algorithm Blind (x, t)→hash(x)^{t}∈ [symbol] , and records an output as a=hash(x)^{t}, and the user equipment sends a to the server. The server performs blind computation BlindEvaluation(k, a)→a^{k}∈ [symbol] , and records an output as b=a^{k}, and the server sends the computation result b to the user equipment. The user equipment performs unblinding

$$unBlind ( b , t ) \to r = {b}^{\frac{1}{t}} ∈ 𝔾 ,$$

and records an output as

$$r = {b}^{\frac{1}{t}} .$$

In this case, the user equipment obtains the OPRF result r.

In an example, the obtaining a random number r includes:
jointly executing the oblivious pseudorandom function OPRF with the server based on the locally held input x and the key k held by the server, to obtain the random number r.

In this example, an additional random source located in the server is introduced by using the OPRF, and information entropy of an authentication system is increased, that is, security of the authentication system is improved. Even if an attacker exhaustively searches for the password of the user through brute force attacks, the attacker needs to jointly execute the OPRF function with the server each time, resulting in higher costs and difficulty of making attacks by the attacker. Otherwise, the attacker can only exhaustively search for the OPRF result of the attacked user, and exhaustion space is a range space of the OPRF, which is much larger than the password space of the user.

Further, the locally held input x is obtained in the following manner:
obtaining a derived password derived_pwd by using a random extraction function and based on the password pwd of the first user, and using the derived password as the input x.

It can be understood that the random extraction function is also referred to as a random extraction algorithm, and can be implemented by a pseudorandom generator (PRG), a DPF, etc. The password pwd is masked by using the random extraction function.

Further, the key k held by the server is obtained in the following manner:

The server obtains the key k by using a random extraction function and based on a seed held by the server.

It can be understood that the seed is masked by using the random extraction function.

Then, in step 23, the public-private key pair including the public key pk and the private key sk is obtained by using the key generation algorithm and based on the random number r and the public parameter pp. It can be understood that in instantiation, it is considered, by default, that each participant uses a fixed public parameter pp obtained through PKEET. Setup(1^{λ})=→pp.

In this embodiment of this specification, r is used as an internal random source of a PKEET initialization algorithm, to ensure that the user can obtain a same result (pk, sk) through restoration in a subsequent login process by using r.

Then, in step 24, a hash operation is performed based on at least the password pwd of the first user, to obtain the user key value user_key. It can be understood that a hash operation can be directly performed on the password pwd of the first user, or a hash operation can be performed on data obtained after the password pwd of the first user is processed, and other information can be added in addition to the password pwd of the first user when the hash operation is performed.

In an example, the performing a hash operation based on at least the password pwd of the first user, to obtain a user key value user_key includes:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

In this example, it is more difficult to crack the password pwd of the first user by using the user key value user_key than by using the derived password derived_pwd, to help improve security.

Then, in step 25, the registration ciphertext C_{register} is obtained by using the encryption algorithm and based on the public key pk and the user key value user_key, where the encryption algorithm generates a random number and performs encryption based on the random number. It can be understood that a random number used by the encryption algorithm in each time of encryption is randomly generated. Therefore, in a case of a same input, outputs of the encryption algorithm in two times of encryption are usually different.

Then, in step 26, the determining trapdoor td_{register} that matches the registration ciphertext C_{register} is obtained by using the trapdoor generation algorithm and based on the private key sk and the registration ciphertext C_{register}. It can be understood that there is a correspondence between a ciphertext and a trapdoor, and there are usually different trapdoors for different ciphertexts.

Finally, in step 27, the registration ciphertext C_{register} and the determining trapdoor td_{register} are uploaded to the server, so that the server stores the registration ciphertext C_{register} and the determining trapdoor td_{register} as the authentication information of the first user, where the authentication information is used to perform identity authentication on the first user. It can be understood that the server does not store a password of a user or a hash value of a password, but stores a registration ciphertext C_{register} and a determining trapdoor td_{register}. In this case, even if the information is disclosed, the password of the user is not easy to obtain, to improve security.

According to the user authentication information-based registration method provided in this embodiment of this specification, user equipment first receives authentication information submitted by a first user in a process of registering with a server, where the authentication information includes a password pwd of the first user; then obtains a random number r; then obtains a public-private key pair including a public key pk and a private key sk by using a key generation algorithm and based on the random number r and a public parameter pp; then performs a hash operation based on at least the password pwd of the first user, to obtain a user key value user_key; then obtains a registration ciphertext C_{register} by using an encryption algorithm and based on the public key pk and the user key value user_key, where the encryption algorithm generates a random number and performs encryption based on the random number; then obtains, by using a trapdoor generation algorithm and based on the private key sk and the registration ciphertext C_{register}, a determining trapdoor td_{register} that matches the registration ciphertext C_{register}; and finally uploads the registration ciphertext C_{register} and the determining trapdoor td_{register} to the server, so that the server stores the registration ciphertext C_{register} and the determining trapdoor td_{register} as authentication information of the first user, where the authentication information is used to perform identity authentication on the first user. It can be learned from the above-mentioned descriptions that in this embodiment of this specification, authentication information stored in the server is not a plaintext password held by a user or a hash value of a password, but is a ciphertext of a user key and a determining trapdoor. In this case, even if the information in the server is disclosed, it is not vulnerable to dictionary attacks, and the information cannot be used to log in to another system that uses a same password. This can improve security and reduce the risk of user privacy disclosure.

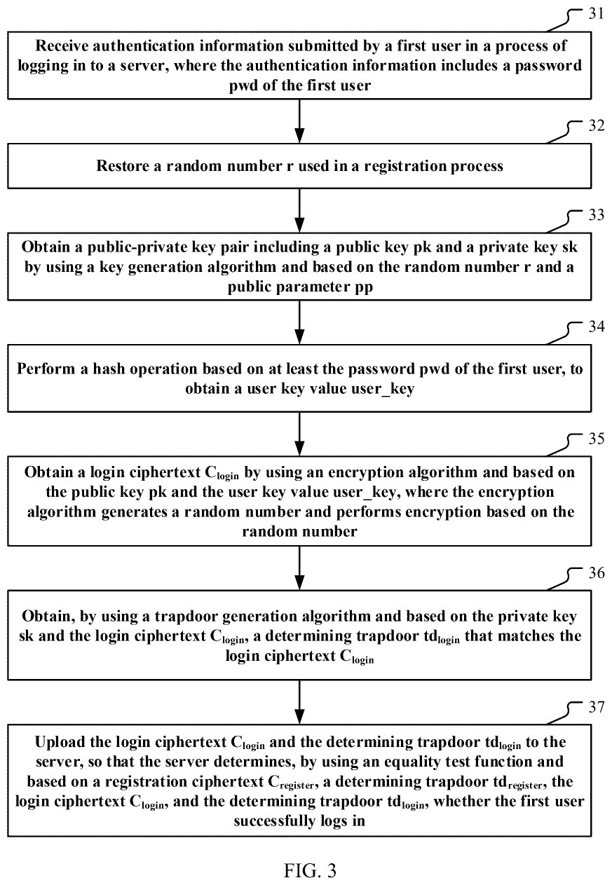

FIG. 3 is a flowchart of a user authentication information-based login method according to an embodiment. The method can be performed by user equipment based on the implementation scenario shown in FIG. 1. As shown in FIG. 3, the user authentication information-based login method in this embodiment includes the following steps: Step 31: Receive authentication information submitted by a first user in a process of logging in to a server, where the authentication information includes a password pwd of the first user; step 32: Restore a random number r used in a registration process; step 33: Obtain a public-private key pair including a public key pk and a private key sk by using a key generation algorithm and based on the random number r and a public parameter pp; step 34: Perform a hash operation based on at least the password pwd of the first user, to obtain a user key value user_key; step 35: Obtain a login ciphertext C_{login} by using an encryption algorithm and based on the public key pk and the user key value user_key, where the encryption algorithm generates a random number and performs encryption based on the random number; step 36: Obtain, by using a trapdoor generation algorithm and based on the private key sk and the login ciphertext C_{login}, a determining trapdoor td_{login} that matches the login ciphertext C_{login}, and step 37: Upload the login ciphertext C_{login} and the determining trapdoor td_{login} to the server, so that the server determines, by using an equality test function and based on a registration ciphertext C_{register}, a determining trapdoor td_{register}, the login ciphertext C_{login}, and the determining trapdoor td_{login}, whether the first user successfully logs in. Specific manners of performing the above-mentioned steps are described below.

First, in step 31, the authentication information submitted by the first user in the process of logging in to the server is received, where the authentication information includes the password pwd of the first user. It can be understood that the first user can input the authentication information to the user equipment by using an input device such as a keyboard.

The password pwd can be a combination of numbers, a combination of numbers and letters, or a combination of numbers, letters, and special symbols, which is easy for the user to remember. There may be many cases, and are not listed one by one herein.

It can be understood that the password pwd is privacy information of the first user, and if the password pwd is obtained by another user, the identity of the first user may be stolen. For example, the another user logs in to a website by using the identity of the first user.

Then, in step 32, the random number r used in the registration process is used. It can be understood that the random number r can be independently generated by the user equipment by using a pseudorandom function, or can be jointly generated by the user equipment and the server by using an oblivious pseudorandom function.

In an example, the restoring a random number r used in a registration process includes:
jointly executing the oblivious pseudorandom function OPRF with the server based on a locally held input x and a key k held by the server, to obtain the random number r.

Further, the locally held input x is obtained in the following manner:
obtaining a derived password derived_pwd by using a random extraction function and based on the password pwd of the first user, and using the derived password as the input x.

Further, the key k held by the server is obtained in the following manner:

The server obtains the key k by using a random extraction function and based on a seed held by the server.

Then, in step 33, the public-private key pair including the public key pk and the private key sk is obtained by using the key generation algorithm and based on the random number r and the public parameter pp. It can be understood that in instantiation, it is considered, by default, that each participant uses a fixed public parameter pp obtained through PKEET. Setup(1^{λ})→pp.

Then, in step 34, a hash operation is performed based on at least the password pwd of the first user, to obtain the user key value user_key. It can be understood that a hash operation can be directly performed on the password pwd of the first user, or a hash operation can be performed on data obtained after the password pwd of the first user is processed, and other information can be added in addition to the password pwd of the first user when the hash operation is performed.

In an example, the performing a hash operation based on at least the password pwd of the first user, to obtain a user key value user_key includes:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

Then, in step 35, the login ciphertext C_{login} is obtained by using the encryption algorithm and based on the public key pk and the user key value user_key, where the encryption algorithm generates a random number and performs encryption based on the random number. It can be understood that a random number used by the encryption algorithm in each time of encryption is randomly generated. Therefore, in a case of a same input, outputs of the encryption algorithm in two times of encryption are usually different, that is, the login ciphertext C_{login} and the registration ciphertext C_{register} are usually different.

Then, in step 36, the determining trapdoor td_{login} that matches the login ciphertext C_{login} is obtained by using the trapdoor generation algorithm and based on the private key sk and the login ciphertext C_{login}. It can be understood that there is a correspondence between a ciphertext and a trapdoor, and there are usually different trapdoors for different ciphertexts.

Finally, in step 37, the login ciphertext C_{login} and the determining trapdoor td_{login} are uploaded to the server, so that the server determines, by using the equality test function and based on the registration ciphertext C_{register}, the determining trapdoor td_{register}, the login ciphertext C_{login}, and the determining trapdoor td_{login}, whether the first user successfully logs in. It can be understood that the server determines, by using the equality test function, whether underlying plaintexts of the login ciphertext C_{login} and the registration ciphertext C_{register} are the same. If the underlying plaintexts of the two ciphertexts are the same, the first user successfully logs in.

In this embodiment of this specification, processing procedures of the user equipment in the login process and the registration process are basically the same, and a difference is only reflected in a processing procedure of the server. The registration process is performed before the login process. In the registration process, the server stores the registration ciphertext C_{register} and the determining trapdoor td_{register}. In the login process, the server performs identity authentication on the first user by using the equality test function and based on the registration ciphertext C_{register}, the determining trapdoor td_{register}, the login ciphertext C_{login}, and the determining trapdoor td_{login}, to determine whether the first user successfully logs in.

According to the user authentication information-based login method provided in this embodiment of this specification, user equipment first receives authentication information submitted by a first user in a process of logging in to a server, where the authentication information includes a password pwd of the first user; then restores a random number r used in a registration process; then obtains a public-private key pair including a public key pk and a private key sk by using a key generation algorithm and based on the random number r and a public parameter pp; then performs a hash operation based on at least the password pwd of the first user, to obtain a user key value user_key; then obtains a login ciphertext C_{login} by using an encryption algorithm and based on the public key pk and the user key value user_key, where the encryption algorithm generates a random number and performs encryption based on the random number; then obtains, by using a trapdoor generation algorithm and based on the private key sk and the login ciphertext C_{login}, a determining trapdoor td_{login} that matches the login ciphertext C_{login}; and finally uploads the login ciphertext C_{login} and the determining trapdoor td_{login} to the server, so that the server determines, by using an equality test function and based on a registration ciphertext C_{register}, a determining trapdoor td_{register}, the login ciphertext C_{login}, and the determining trapdoor td_{login}, whether the first user successfully logs in. It can be learned from the above-mentioned descriptions that in a user login process, authentication information transmitted by the user equipment to the server is not a plaintext password held by a user or a hash value of a password, but is a ciphertext of a user key and a determining trapdoor. In this case, even if the information is disclosed in a transmission process, the information cannot be used to log in to another system that uses a same password. This can improve security and reduce the risk of user privacy disclosure.

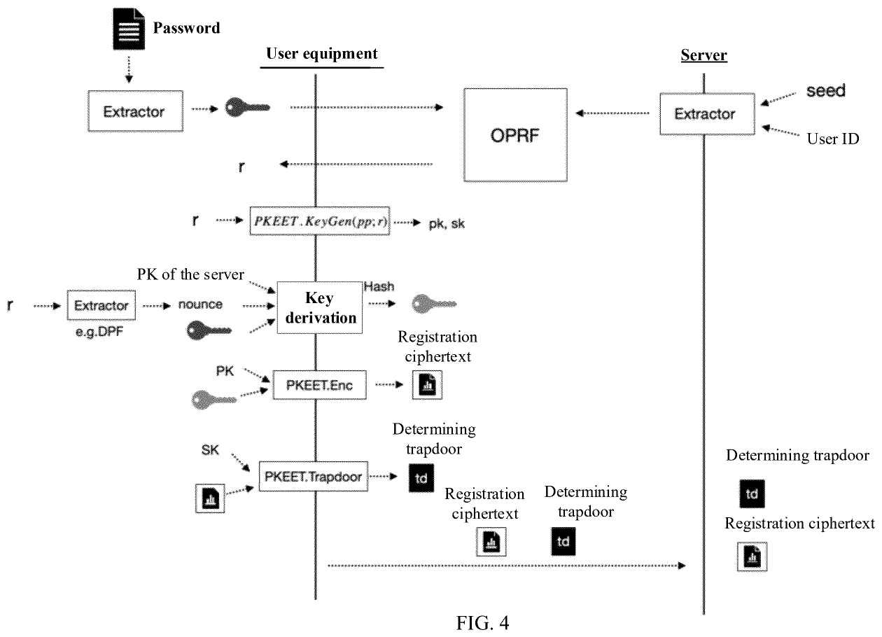

FIG. 4 is a schematic interaction diagram of a user authentication information-based registration phase according to an embodiment. The registration phase involves interaction processing between user equipment and a server. With reference to FIG. 4, the user equipment receives a password pwd input by a user, and invokes an extraction algorithm Extractor(pwd, “password”) to obtain a derived password derived_pwd. The server performs derivation Extractor(seed, ID) by using a seed held by the server and an ID of the registered user, to obtain an OPRF key k. A consistent seed is maintained in the server, and the Extractor algorithm represents a type of random extraction algorithm. An OPRF protocol is run between the user equipment and the server. The user equipment randomly selects a random number t to obtain a blind value a=hash(pwd)^{t} of the password, and sends a to the server. The server computes b=a^{k} based on the OPRF key k, and sends the result to the user equipment. The user equipment obtains an output random number r=b^{1/t} of the OPRF.

The user equipment uses the random number r, and the user equipment runs PKEET. KeyGen(pp; r) to obtain(pk, sk), wherein r is used as an internal random source of a PKEET initialization algorithm, to ensure that the user can obtain a same result (pk, sk) through restoration in a subsequent login process by using r. In instantiation, it is considered, by default, that each participant uses a fixed public parameter pp obtained through PKEET.Setup(1^{λ})→pp. The user equipment runs a key derivation algorithm, and uses derived_pwd, PK of the server, and nounce as inputs to obtain an actual key value user_key=Hash(pwd∥PK of the server∥nounce∥OtherInfo). It is considered, by default, that OtherInfo herein is null, or other information can be added as required. The PK of the server can be a domain name of the server or pk information in a TLS certificate of the server. The value nounce is computed by using an extraction algorithm Extractor (r,“random∥PK of the server”)→nounce. The user equipment runs an algorithm PKEET.Enc(pk, user_key) to obtain a registration ciphertext c_{register}. The user equipment runs an algorithm PKEET.Trapdoor(sk, c_{register}) to obtain a determining trapdoor td_{register}. The user uploads the registration ciphertext c_{register} and the determining trapdoor td_{register} to the server, and the server stores corresponding registration information.

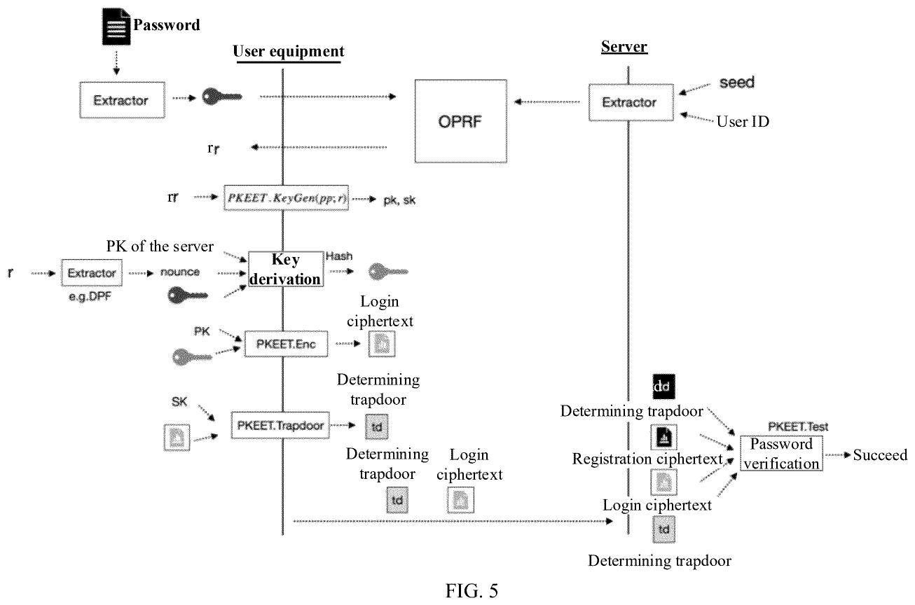

FIG. 5 is a schematic interaction diagram of a user authentication information-based login phase according to an embodiment. The login phase involves interaction processing between user equipment and a server. With reference to FIG. 5, the user equipment receives a password pwd input by a user, and invokes an extraction algorithm Extractor(pwd, “password”) to obtain a derived password derived_pwd. The server performs derivation Extractor (seed, ID) by using a seed held by the server and an ID of the registered user, to obtain an OPRF key k. An OPRF protocol is run between the user equipment and the server. The user equipment obtains, through restoration, a random number r used in a registration process.

The user equipment uses the random number r, and the user equipment runs PKEET.KeyGen(pp; r) to obtain (pk, sk), wherein r is used as an internal random source of a PKEET initialization algorithm, to ensure that the user can obtain a same result (pk, sk) through restoration in a subsequent login process by using r. The user equipment runs a key derivation algorithm, and uses derived_pwd, PK of the server, and nounce as inputs to obtain an actual key value user_key=Hash(pwd∥PK of the server∥nounce∥OtherInfo). It is considered, by default, that OtherInfo herein is null, or other information can be added as required. The value nounce is computed by using an extraction algorithm Extractor (r,“random∥PK of the server”)→nounce. The user equipment runs an algorithm PKEET.Enc(pk, user_key) to obtain a login ciphertext c_{login}. The user equipment runs an algorithm PKEET.Trapdoor(sk,c_{login}) to obtain a determining trapdoor td_{login}. The user equipment uploads the login ciphertext c_{login} and the determining trapdoor td_{login} to the server. The server runs an algorithm PKEET.Test(td_{login}, c_{login}, td_{register}, c_{register}). If the algorithm outputs 1, it indicates that underlying plaintexts of the ciphertexts are the same, that is, there is a same password pwd, and the user successfully logs in. Otherwise, if the algorithm outputs 0, the user fails to log in.

In this embodiment of this specification, a public key encryption algorithm with equality test is used, and information stored in the server is a ciphertext of a user key and a determining trapdoor. In this case, even if the information in the server is disclosed, including seed disclosure of the OPRF, it is not vulnerable to dictionary attacks, and the information cannot be used to log in to another system that uses a same password. In addition, even if the authentication information in a transmission process is stolen, the authentication information cannot be used to log in to another system that uses a same password.

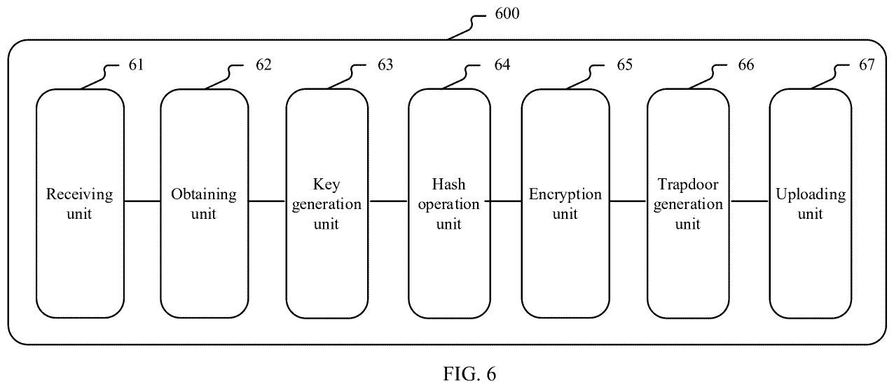

According to an embodiment in another aspect, a user authentication information-based registration apparatus is further provided. The apparatus is disposed in user equipment, and is configured to perform the method shown in FIG. 2 provided in the embodiments of this specification. FIG. 6 is a schematic block diagram of a user authentication information-based registration apparatus according to an embodiment. As shown in FIG. 6, the apparatus 600 includes:
a receiving unit 61, configured to receive authentication information submitted by a first user in a process of registering with a server, wherein the authentication information includes a password pwd of the first user;
an obtaining unit 62, configured to obtain a random number r;
a key generation unit 63, configured to obtain a public-private key pair including a public key pk and a private key sk by using a key generation algorithm and based on the random number r obtained by the obtaining unit 62 and a public parameter pp;
a hash operation unit 64, configured to perform a hash operation based on at least the password pwd of the first user received by the receiving unit 61, to obtain a user key value user_key;
an encryption unit 65, configured to obtain a registration ciphertext C_{register} by using an encryption algorithm and based on the public key pk obtained by the key generation unit 63 and the user key value user_key obtained by the hash operation unit 64, wherein the encryption algorithm generates a random number and performs encryption based on the random number;
a trapdoor generation unit 66, configured to obtain, by using a trapdoor generation algorithm and based on the private key sk obtained by the key generation unit 63 and the registration ciphertext C_{register} obtained by the encryption unit 65, a determining trapdoor td_{register} that matches the registration ciphertext C_{register}, and
an uploading unit 67, configured to upload the registration ciphertext C_{register} obtained by the encryption unit 65 and the determining trapdoor td_{register} obtained by the trapdoor generation unit 66 to the server, so that the server stores the registration ciphertext C_{register} and the determining trapdoor td_{register} as authentication information of the first user, wherein the authentication information is used to perform identity authentication on the first user.

Optionally, in an embodiment, the obtaining unit 62 is specifically configured to jointly execute an oblivious pseudorandom function OPRF with the server based on a locally held input x and a key k held by the server, to obtain the random number r.

Further, the locally held input x is obtained in the following manner:
obtaining a derived password derived_pwd by using a random extraction function and based on the password pwd of the first user, and using the derived password as the input x.

Further, the key k held by the server is obtained in the following manner:

The server obtains the key k by using a random extraction function and based on a seed held by the server.

Further, the hash operation unit 64 includes:
a random extraction subunit, configured to obtain a computed value nounce by using a random extraction function and based on the random number r; and
a hash operation subunit, configured to: concatenate the derived password derived_pwd corresponding to the password pwd of the first user, the computed value nounce obtained by the random extraction subunit, and public information PK of the server, and then perform a hash operation, to obtain the user key value user_key.

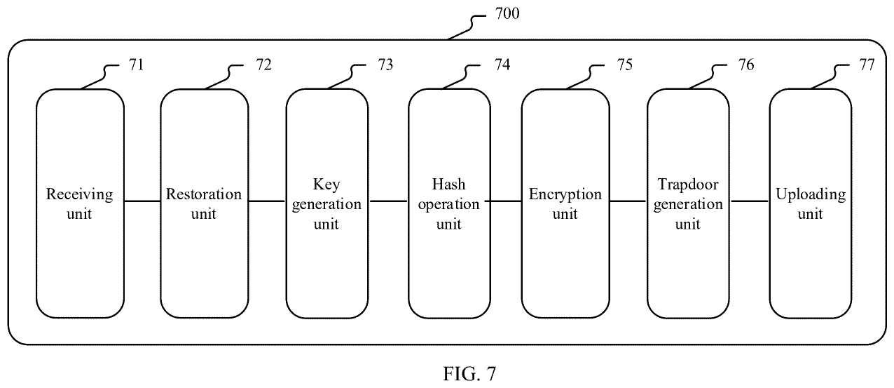

According to an embodiment in another aspect, a user authentication information-based login apparatus is further provided. The apparatus is disposed in user equipment, and is configured to perform the method shown in FIG. 3 provided in the embodiments of this specification. FIG. 7 is a schematic block diagram of a user authentication information-based login apparatus according to an embodiment. As shown in FIG. 7, the apparatus 700 includes:
a receiving unit 71, configured to receive authentication information submitted by a first user in a process of logging in to a server, wherein the authentication information includes a password pwd of the first user;
a restoration unit 72, configured to restore a random number r used in a registration process;
a key generation unit 73, configured to obtain a public-private key pair including a public key pk and a private key sk by using a key generation algorithm and based on the random number r obtained by the restoration unit 72 and a public parameter pp;
a hash operation unit 74, configured to perform a hash operation based on at least the password pwd of the first user obtained by the receiving unit 71, to obtain a user key value user_key;
an encryption unit 75, configured to obtain a login ciphertext C_{login} by using an encryption algorithm and based on the public key pk obtained by the key generation unit 73 and the user key value user_key obtained by the hash operation unit 74, wherein the encryption algorithm generates a random number and performs encryption based on the random number;
a trapdoor generation unit 76, configured to obtain, by using a trapdoor generation algorithm and based on the private key sk obtained by the key generation unit 73 and the login ciphertext C_{login} obtained by the encryption unit 75, a determining trapdoor td_{login} that matches the login ciphertext C_{login}, and
an uploading unit 77, configured to upload the login ciphertext C_{login} obtained by the encryption unit 75 and the determining trapdoor td_{login} obtained by the trapdoor generation unit 76 to the server, so that the server determines, by using an equality test function and based on a registration ciphertext C_{register}, a determining trapdoor td_{register}, the login ciphertext C_{login}, and the determining trapdoor td_{login}, whether the first user successfully logs in.

Optionally, in an embodiment, the restoration unit 72 is specifically configured to jointly execute an oblivious pseudorandom function OPRF with the server based on a locally held input x and a key k held by the server, to obtain the random number r.

Further, the locally held input x is obtained in the following manner:
obtaining a derived password derived_pwd by using a random extraction function and based on the password pwd of the first user, and using the derived password as the input x.

Further, the key k held by the server is obtained in the following manner:

The server obtains the key k by using a random extraction function and based on a seed held by the server.

Further, the hash operation unit 74 includes:
a random extraction subunit, configured to obtain a computed value nounce by using a random extraction function and based on the random number r; and
a hash operation subunit, configured to: concatenate the derived password derived_pwd corresponding to the password pwd of the first user, the computed value nounce obtained by the random extraction subunit, and public information PK of the server, and then perform a hash operation, to obtain the user key value user_key.

According to an embodiment in another aspect, a computer-readable storage medium is further provided. The computer-readable storage medium stores a computer program, and when the computer program is executed in a computer, the computer is enabled to perform the method described with reference to FIG. 2 or FIG. 3.

According to an embodiment in still another aspect, a computing device is further provided, including a memory and a processor. The memory stores executable code, and when the processor executes the executable code, the method described with reference to FIG. 2 or FIG. 3 is implemented.

A person skilled in the art should be aware that in the above-mentioned one or more examples, the functions described in this specification can be implemented by hardware, software, firmware, or any combination thereof. When being implemented by software, these functions can be stored in a computer-readable medium or transmitted as one or more instructions or code on a computer-readable medium.

In the above-mentioned specific implementations, the objectives, technical solutions, and beneficial effects of this specification are further described in detail. It should be understood that the above-mentioned descriptions are merely specific implementations of this specification, but are not intended to limit the protection scope of this specification. Any modification, equivalent replacement, improvement, etc. made based on the technical solutions of this specification shall fall within the protection scope of this specification.

1. A user authentication information-based registration method, wherein the method is performed by user equipment and comprises:
receiving authentication information submitted by a first user in a process of registering with a server, wherein the authentication information comprises a password pwd of the first user;
obtaining a random number r;
obtaining a public-private key pair comprising a public key pk and a private key sk by using a key generation algorithm and based on the random number r and a public parameter pp;
performing a hash operation based on at least the password pwd of the first user, to obtain a user key value user_key;
obtaining a registration ciphertext C_{register} by using an encryption algorithm and based on the public key pk and the user key value user_key, wherein the encryption algorithm generates a random number and performs encryption based on the random number;
obtaining, by using a trapdoor generation algorithm and based on the private key sk and the registration ciphertext C_{register}, a determining trapdoor td_{register} that matches the registration ciphertext C_{register}, and
uploading the registration ciphertext C_{register} and the determining trapdoor td_{register} to the server, so that the server stores the registration ciphertext C_{register} and the determining trapdoor td_{register} as authentication information of the first user, wherein the authentication information is used to perform identity authentication on the first user.

2. The method according to claim 1, wherein the obtaining a random number r comprises:
jointly executing an oblivious pseudorandom function OPRF with the server based on a locally held input x and a key k held by the server, to obtain the random number r.

3. The method according to claim 2, wherein the locally held input x is obtained in the following manner:
obtaining a derived password derived_pwd by using a random extraction function and based on the password pwd of the first user, and using the derived password as the input x.

4. The method according to claim 2, wherein the key k held by the server is obtained in the following manner:
the server obtains the key k by using a random extraction function and based on a seed held by the server.

5. The method according to claim 3, wherein the performing a hash operation based on at least the password pwd of the first user, to obtain a user key value user_key comprises:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

6. A user authentication information-based login method, wherein the method is performed by user equipment and comprises:
receiving authentication information submitted by a first user in a process of logging in to a server, wherein the authentication information comprises a password pwd of the first user;
restoring a random number r used in a registration process;
obtaining a public-private key pair comprising a public key pk and a private key sk by using a key generation algorithm and based on the random number r and a public parameter pp;
performing a hash operation based on at least the password pwd of the first user, to obtain a user key value user_key;
obtaining a login ciphertext C_{login} by using an encryption algorithm and based on the public key pk and the user key value user_key, wherein the encryption algorithm generates a random number and performs encryption based on the random number;
obtaining, by using a trapdoor generation algorithm and based on the private key sk and the login ciphertext C_{login}, a determining trapdoor td_{login} that matches the login ciphertext C_{login}; and
uploading the login ciphertext C_{login} and the determining trapdoor td_{login} to the server, so that the server determines, by using an equality test function and based on a registration ciphertext C_{register}, a determining trapdoor td_{register}, the login ciphertext C_{login}, and the determining trapdoor td_{login}, whether the first user successfully logs in.

7. The method according to claim 6, wherein the restoring a random number r used in a registration process comprises:
jointly executing an oblivious pseudorandom function OPRF with the server based on a locally held input x and a key k held by the server, to obtain the random number r.

8. The method according to claim 7, wherein the locally held input x is obtained in the following manner:
obtaining a derived password derived_pwd by using a random extraction function and based on the password pwd of the first user, and using the derived password as the input x.

9. The method according to claim 7, wherein the key k held by the server is obtained in the following manner:
the server obtains the key k by using a random extraction function and based on a seed held by the server.

10. The method according to claim 8, wherein the performing a hash operation based on at least the password pwd of the first user, to obtain a user key value user_key comprises:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

11. A computing device, comprising a memory and a processor, wherein the memory stores executable code, and when the processor executes the executable code, the processor is caused to implement a user authentication information-based registration method, wherein the method is performed by user equipment and comprises:
receiving authentication information submitted by a first user in a process of registering with a server, wherein the authentication information comprises a password pwd of the first user;
obtaining a random number r;
obtaining a public-private key pair comprising a public key pk and a private key sk by using a key generation algorithm and based on the random number r and a public parameter pp;
performing a hash operation based on at least the password pwd of the first user, to obtain a user key value user_key;
obtaining a registration ciphertext C_{register} by using an encryption algorithm and based on the public key pk and the user key value user_key, wherein the encryption algorithm generates a random number and performs encryption based on the random number;
obtaining, by using a trapdoor generation algorithm and based on the private key sk and the registration ciphertext C_{register}, a determining trapdoor td_{register} that matches the registration ciphertext C_{register}, and
uploading the registration ciphertext C_{register} and the determining trapdoor td_{register} to the server, so that the server stores the registration ciphertext C_{register} and the determining trapdoor td_{register} as authentication information of the first user, wherein the authentication information is used to perform identity authentication on the first user.

12. The computing device according to claim 11, wherein the obtaining a random number r comprises:
jointly executing an oblivious pseudorandom function OPRF with the server based on a locally held input x and a key k held by the server, to obtain the random number r.

13. The computing device according to claim 12, wherein the locally held input x is obtained in the following manner:
obtaining a derived password derived_pwd by using a random extraction function and based on the password pwd of the first user, and using the derived password as the input x.

14. The computing device according to claim 12, wherein the key k held by the server is obtained in the following manner:
the server obtains the key k by using a random extraction function and based on a seed held by the server.

15. The computing device according to claim 13, wherein the performing a hash operation based on at least the password pwd of the first user, to obtain a user key value user_key comprises:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.

16. The computing device according to claim 11, the computing device is further caused to implement a user authentication information-based login method, wherein the method is performed by user equipment and comprises:
receiving authentication information submitted by a first user in a process of logging in to a server, wherein the authentication information comprises a password pwd of the first user;
restoring a random number r used in a registration process;
obtaining a public-private key pair comprising a public key pk and a private key sk by using a key generation algorithm and based on the random number r and a public parameter pp;
performing a hash operation based on at least the password pwd of the first user, to obtain a user key value user_key;
obtaining a login ciphertext C_{login} by using an encryption algorithm and based on the public key pk and the user key value user_key, wherein the encryption algorithm generates a random number and performs encryption based on the random number;
obtaining, by using a trapdoor generation algorithm and based on the private key sk and the login ciphertext C_{login}, a determining trapdoor td_{login} that matches the login ciphertext C_{login}; and
uploading the login ciphertext C_{login} and the determining trapdoor td_{login} to the server, so that the server determines, by using an equality test function and based on a registration ciphertext C_{register}, a determining trapdoor td_{register}, the login ciphertext C_{login}, and the determining trapdoor td_{login}, whether the first user successfully logs in.

17. The computing device according to claim 16, wherein the restoring a random number r used in a registration process comprises:
jointly executing an oblivious pseudorandom function OPRF with the server based on a locally held input x and a key k held by the server, to obtain the random number r.

18. The computing device according to claim 17, wherein the locally held input x is obtained in the following manner:
obtaining a derived password derived_pwd by using a random extraction function and based on the password pwd of the first user, and using the derived password as the input x.

19. The computing device according to claim 17, wherein the key k held by the server is obtained in the following manner:
the server obtains the key k by using a random extraction function and based on a seed held by the server.

20. The computing device according to claim 18, wherein the performing a hash operation based on at least the password pwd of the first user, to obtain a user key value user_key comprises:
obtaining a computed value nounce by using a random extraction function and based on the random number r; and
concatenating the derived password derived_pwd corresponding to the password pwd of the first user, the computed value nounce, and public information PK of the server, and then performing a hash operation, to obtain the user key value user_key.
